(19) United States
(12) Patent Application Publication
(10) Pub. No.: US 2026/0070756 A1
(43) Pub. Date: Mar. 12, 2026

(54) SOFTWARE UPDATE FOR A FLEET OF PASSENGER CONVEYORS

(71) Applicant: Kone Corporation, Helsinki (FI)

(72) Inventors: Matti MUSTONEN, Helsinki (FI); Ferenc STAENGLER, Helsinki (FI)

(73) Assignee: Kone Corporation, Helsinki (FI)

(21) Appl. No.: 19/394,444

(22) Filed: Nov. 19, 2025

Related U.S. Application Data
(63) Continuation of application No. PCT/FI2023/050332, filed on Jun. 7, 2023.

(51) Int. Cl. B66B 1/34; G06F 8/65

(52) U.S. Cl. CPC B66B 1/3407; G06F 8/65

(57) ABSTRACT

A method for managing a software update of a fleet of passenger conveyors is provided, the method comprises: dividing the fleet of passenger conveyors to a plurality of sub-groups; selecting a first sub-group of passenger conveyors from the fleet of sub-groups for the software update; delivering data to one or more passenger conveyors belonging to the first sub-group of passenger conveyors for performing the software update; receiving data indicative on a state of the software update in the first sub-group of passenger conveyors; and selecting at least one second sub-group of passenger conveyors for the software update. Also a control system and a computer program are provided to.

### CROSS-REFERENCE TO RELATED APPLICATIONS

This application is a continuation of PCT International Application No. PCT/FI2023/050332 which has an International filing date of Jun. 7, 2023, the entire contents of which are incorporated herein by reference.

### TECHNICAL FIELD

The invention concerns in general the technical field of passenger conveyors. More particularly, the invention concerns a management of software update of passenger conveyors.

### BACKGROUND

Continuously increasing presence of software in passenger conveyors, such as in elevators, escalators, and moving walkways, brings along a challenge to keep the software updated. The software update in the passenger conveyor environment wherein there are typically a huge number of updateable entities geographically spread all over the world is extremely challenging. This requires that the management of the software updates is performed through one or more software management servers, or software management systems, remotely by utilizing sophisticated communication technologies.

The software update process itself is always a risk if something goes wrong. Such situation may e.g. occur due to that the software testing and piloting has not been comprehensive enough before the update is initiated. For example, an implementation of the testing and the piloting may have shortages in terms of not being performed to all possible configurations of the passenger conveyors which may cause surprises during the update. Any such unsuccessful software update may cause out-of-service/callout situations in the sites which—in turn—causes dissatisfaction by the users of the passenger conveyors. This may also be challenging to repair due to that it may even require a visit of the maintenance personnel at the site to solve the unsuccessful software update situation and when the software update is performed simultaneously and globally the resources to recover the situation may run out in a very fast manner.

Therefore, there is a need to introduce novel approaches for performing the software update of the passenger conveyors in a more guaranteed way than the prior art solutions.

### SUMMARY

The following presents a simplified summary in order to provide basic understanding of some aspects of various invention embodiments. The summary is not an extensive overview of the invention. It is neither intended to identify key or critical elements of the invention nor to delineate the scope of the invention. The following summary merely presents some concepts of the invention in a simplified form as a prelude to a more detailed description of exemplifying embodiments of the invention.

An object of the invention is to present a method, a control system and a computer program for managing a software update of a fleet of passenger conveyors.

The objects of the invention are reached by a method, a control system and a computer program as defined by the respective independent claims.

According to a first aspect, A method for managing a software update of a fleet of passenger conveyors is provided, the method, performed by a control system, comprises:
dividing the fleet of passenger conveyors to a plurality of sub-groups of passenger conveyors in order to perform the software update on a sub-group basis, the division is performed by applying at least one criterion in allocating a passenger conveyor to the sub-group,
selecting a first sub-group of passenger conveyors from the fleet of sub-groups for the software update,
delivering data to one or more passenger conveyors belonging to the first sub-group of passenger conveyors for performing the software update,
receiving data indicative on a state of the software update in the first sub-group of passenger conveyors,
selecting, in response to a detection that the state of the software update in the first sub-group of passenger conveyors meets a reference value, at least one second sub-group of passenger conveyors for the software update.

The division to the plurality of sub-groups of passenger conveyors may be performed based on at least one characteristic of the passenger conveyors. For example, at least one predefined rule may additionally be applied in the division to the plurality of sub-groups of passenger conveyors. Still further, the at least one predefined rule may cause at least one of the following: a prevention to include all passenger conveyors from a same conveyor group to the sub-group in the division; controlling the number of passenger conveyors from a predefined area to be included to the sub-group in the division.

Moreover, the division of the passenger conveyors to the sub-group may be adjusted based on a detection result descriptive of the state of the software update in at least one previous sub-group of passenger conveyors.

The data delivered to the one or more passenger conveyors belonging to the first sub-group of passenger conveyors may comprise at least one of the following: data package comprising the data of the software update; a triggering data causing the passenger conveyor receiving the triggering data to perform the software update.

The detection may be performed over a predefined time window.

Further, the method may further comprise:
generating, in response to a detection that the state of the software update in the first sub-group of passenger conveyors does not meet the predefined reference value, a control signal to cancel the software update.

In response to the canceling of the software update a control signal may be generated to the first sub-group of passenger conveyors to cause a roll-back to a previous software version.

According to a second aspect, a control system for managing a software update of a fleet of passenger conveyors is provided, the control system is configured to:
divide the fleet of passenger conveyors to a plurality of sub-groups of passenger conveyors in order to perform the software update on a sub-group basis, the division is performed by applying at least one criterion in allocating a passenger conveyor to the sub-group,
select a first sub-group of passenger conveyors from the fleet of sub-groups for the software update,
deliver data to one or more passenger conveyors belonging to the first sub-group of passenger conveyors for performing the software update,
receive data indicative on a state of the software update in the first sub-group of passenger conveyors,
select, in response to a detection that the state of the software update in the first sub-group of passenger conveyors meets a reference value, at least one second sub-group of passenger conveyors for the software update.

The control system may be configured to perform the division to the plurality of sub-groups of passenger conveyors based on at least one characteristic of the passenger conveyors. For example, the control system may be configured to additionally apply at least one predefined rule in the division to the plurality of sub-groups of passenger conveyors. The application of the at least one predefined rule may cause the control system to perform at least one of the following: a prevention to include all passenger conveyors from a same conveyor group to the sub-group in the division; controlling the number of passenger conveyors from a predefined area to be included to the sub-group in the division.

Moreover, the control system may be configured to adjust the division of the passenger conveyors to the sub-group based on a detection result descriptive of the state of the software update in at least one previous sub-group of passenger conveyors.

The control system may also be configured to include in the data delivered to the one or more passenger conveyors belonging to the first sub-group of passenger conveyors at least one of the following: data package comprising the data of the software update; a triggering data causing the passenger conveyor receiving the triggering data to perform the software update.

Still further, the control system may be configured to perform the detection over a predefined time window.

The control system may further be configured to:
generate, in response to a detection that the state of the software update in the first sub-group of passenger conveyors does not meet the pre-defined reference value, a control signal to cancel the software update.

The control system may be configured to, in response to the canceling of the software update, generate a control signal to the first sub-group of passenger conveyors to cause a roll-back to a previous software version.

According to a third aspect, a computer program is provided, the computer program comprising instructions to cause the device of according to the second aspect as defined above to execute the steps of the method according to the first aspect as defined above.

The expression “a number of” refers herein to any positive integer starting from one, e.g. to one, two, or three.

The expression “a plurality of” refers herein to any positive integer starting from two, e.g. to two, three, or four.

Various exemplifying and non-limiting embodiments of the invention both as to constructions and to methods of operation, together with additional objects and advantages thereof, will be best understood from the following description of specific exemplifying and non-limiting embodiments when read in connection with the accompanying drawings.

The verbs “to comprise” and “to include” are used in this document as open limitations that neither exclude nor require the existence of unrecited features. The features recited in dependent claims are mutually freely combinable unless otherwise explicitly stated. Furthermore, it is to be understood that the use of “a” or “an”, i.e. a singular form, throughout this document does not exclude a plurality.

### BRIEF DESCRIPTION OF FIGURES

The embodiments of the invention are illustrated by way of example, and not by way of limitation, in the figures of the accompanying drawings.

FIG. 1 illustrates schematically a system according to an example.

FIG. 2 illustrates schematically a structure of a software package according to an example.

FIG. 3 illustrates schematically a method according to an example.

FIG. 4 illustrates schematically an apparatus according to an example.

### DESCRIPTION OF THE EXEMPLIFYING EMBODIMENTS

The specific examples provided in the description given below should not be construed as limiting the scope and/or the applicability of the appended claims. Lists and groups of examples provided in the description given below are not exhaustive unless otherwise explicitly stated.

A party, such as a maintenance company of a passenger conveyor or a manufacturer of a passenger conveyor, may manage a huge number of passenger conveyors locating geographically distantly from each other. The passenger conveyors managed by such a party may be called as a fleet of passenger conveyors which describes the nature of the setup as well as distinguishes it e.g. from a locally residing elevator group. In other words, the number of passenger conveyors in the fleet may be tens, typically hundreds or even thousands. The passenger conveyors belonging to the fleet may reside in various application areas, such as in residential buildings, office buildings, hospitals, shopping centers, ships, and the like. The management of the fleet of the passenger conveyors here refers to a management of software in the respective passenger conveyors and especially to perform a software update to the fleet of conveyor systems in a manner as described in the forthcoming description. For sake of clarity it is worthwhile to mention that the term passenger conveyor covers elevators, escalators and moving walkways and similar conveyor systems suitable for carrying passengers and corresponding load.

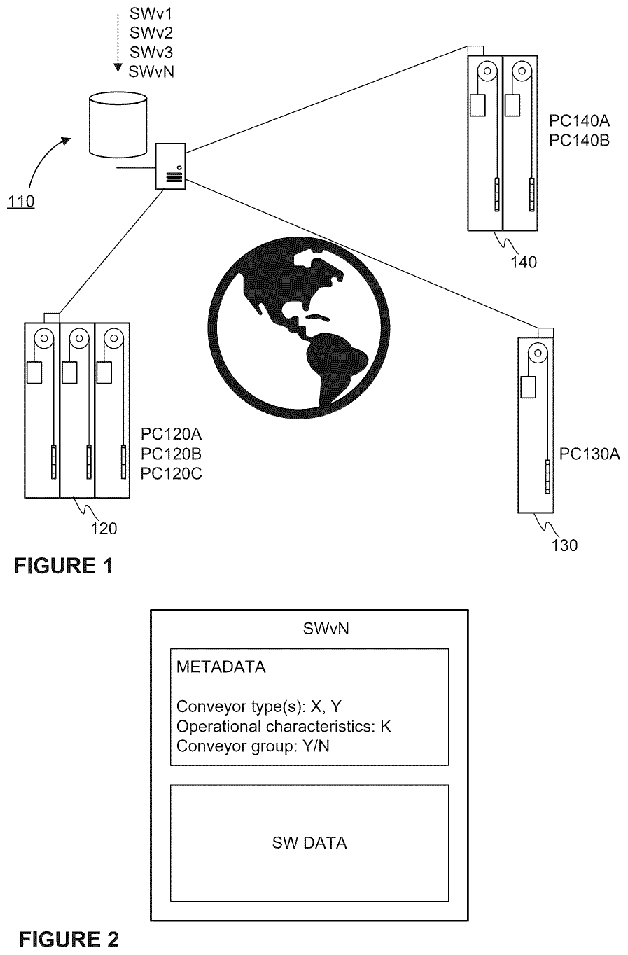

At least some aspects of the invention is described with respect to a fleet of passenger conveyors as schematically illustrated in FIG. 1 as a non-limiting example of an implementation of the invention. The system as schematically illustrated in FIG. 1 comprises a control system 110 and the fleet of passenger conveyors consisting of various types of passenger conveyor systems which are denoted with 120, 130, 140 in FIG. 1. The symbol of the globe in FIG. 1 is for emphasizing the nature of the fleet of passenger conveyors wherein the passenger conveyors reside at least in part geographically distantly to each other. The term passenger conveyor system 120, 130, 140 herein shall be understood to comprise one or more conveyors, such as elevators, escalators, or moving walkways, at each location so as to form different kinds of conveyor groups at the respective sites. For sake of clarity, the conveyors are denoted with PC120A, PC120B, PC120C for the passenger conveyor system denoted with 120 in FIG. 1, PC130A for the passenger conveyor system denoted with 130 in FIG. 1, and PC140A, PC140B for the passenger conveyor system denoted with 140 in FIG. 1. For sake of completeness it is worthwhile to mention that the passenger conveyors belonging to passenger conveyor system 120, 130, 140 may be similar to each other or they may at least in part be different types of passenger conveyors, i.e. comprising e.g. different components and/or configured to operate in a different manner.

The fleet of passenger conveyors implemented with the passenger conveyor systems 120, 130, 140 in the described manner are communicatively connected by applying known communication technologies to the control system 110. In other words, the communication connection may be arranged separately to each passenger conveyor belonging to each system 120, 130, 140 or only to one passenger conveyor of the respective system 120, 130, 140. The control system 110 may e.g. refer to a server, or a group of servers e.g. arranged to operate in a cloud computing environment, which is configured to manage software executed by the passenger conveyors belonging to the fleet of passenger conveyors. The control system 110 may e.g. comprise a database configured to store one or more software versions of the passenger conveyors and to receive new releases of the software versions. The server of the control system 110 may be configured to receive information on the new releases stored in the database, e.g. by polling the new releases from the database or by receiving an indication of the new releases e.g. when uploaded in the database. The control system 110 may be configured to deliver the new release in the context of the procedure as is described in the forthcoming description or the new release may be delivered to the respective passenger conveyors under a separate delivery scheme and the procedure described in the forthcoming description utilizes such a pre-delivered data package in the procedure. In the latter approach the delivery of the new release to the passenger conveyors in question may also be performed by another entity than the control system 110. The control system 110 may e.g. be made aware of such deliveries e.g. by using acknowledgement signaling therein in order to initiate the proceedings as described in the following paragraphs.

Moreover, the control system 110 may store data, or have access to data, defining characteristics of the passenger conveyors belonging to the fleet managed by the control system 110. Such data may comprise information on a type of each passenger conveyor, operational characteristics (e.g. nominal speed/load) per each passenger conveyor, information indicative if the passenger conveyor belongs to a conveyor group or not, customer segment the passenger conveyor is serving, and so on. In other words, the control system 110 may have access to data descriptive of the passenger conveyor(s) belonging to the fleet managed by the control system 110 wherein the pieces of data are descriptive of predefined aspects of the passenger conveyors. Additionally, the data with respect to each passenger conveyor may comprise contact information and/or location information on the passenger conveyors wherein the contact information may e.g. refer to a communication network address, for example. The data defining at least some characteristics of the passenger conveyors may be stored in an applicable manner, such as by applying a tree-structure, so as to make the data searchable in an efficient manner from the data storage, such as from a data storage implemented as a database.

As regards to the releases in the form of the software packages they may be provided with metadata together with the software data. An example of such a structure of the software package is schematically illustrated in FIG. 2. The metadata may comprise information defining one or more requirements of passenger conveyors for which the respective software package is dedicated to in order to update the software executed in the respective passenger conveyor(s). For example, the metadata may define type(s) of the passenger conveyors the data package is intended to be applied to. Additionally, it may e.g. define operational characters of the passenger conveyors which may e.g. refer to preset operational parameters of the respective passenger conveyors for which the new software update is released. Still further, the metadata may define if the software package is only meant for passenger conveyors belonging to a conveyor group or if it is only for single passenger conveyors. The metadata may define further aspects, such as customer segments the data package is intended for as well as information defining at least at some extent an instant the update shall be performed. The given aspects of the metadata are non-limiting examples.

Generally speaking the above described data descriptive of the passenger conveyors belonging to the fleet and the metadata included in the data package defines at least in part corresponding aspects so that these may be matched in a manner described in the forthcoming description.

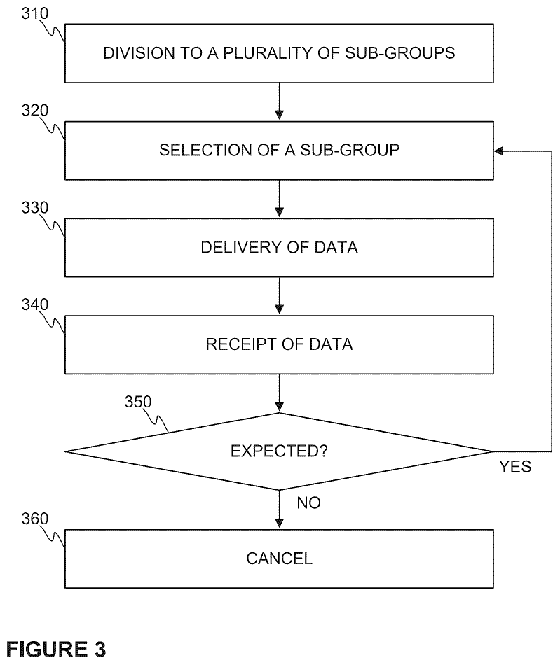

Next at least some aspects of the invention is described by referring to FIG. 3 schematically illustrating a method according to an embodiment. The method is for managing a software update of a fleet of passenger conveyors and is shown from a perspective of a control system 110, which may refer to a software update server or similar as discussed in the foregoing description.

In step 310 of the method the fleet of passenger conveyors is divided to a plurality of sub-groups of passenger conveyors. This is done in order to perform the software update on a sub-group basis which refers to that the software update is performed in at least two sub-groups consequently to each other. The division 310 of the fleet to the plurality of sub-groups is performed by applying at least one criterion in allocating a passenger conveyor to the sub-group. In other words, the passenger conveyors belonging to the fleet are allocated to a plurality of sub-groups. For sake of example, one sub-group may be formed by the conveyors denoted with PC120A, PC130A, PC130A in FIG. 1, a second sub-group by conveyors denoted with PC120B, PC140B in FIG. 1 and the third sub-group by a conveyor denoted with PC120C.

The division 310 of the fleet to the sub-groups may be performed e.g. when the fleet is established and whenever a new passenger conveyor is added to the fleet it is allocated to one sub-group based on the at least one criterion. The criterion may e.g. refer to the one or more characteristics of the passenger conveyors as discussed in the foregoing description. For example, the passenger conveyors may be divided to various sub-groups only based on their type. Alternatively or in addition, further characteristics may be used alone or together with each other, such as locations of the passenger conveyors or any other characteristic.

On the other hand, the division 310 to the sub-groups may be arranged to occur in response to one or more predefined events. Such an event may e.g. be a receipt of predefined data by the control system 110 wherein the data may refer to a receipt of a number of data packages for performing software update to passenger conveyors of a certain type. For example, the predefined data may instruct the control system 110 to perform a search of a first type of passenger conveyors and a second type of passenger conveyors from the database based on one or more criteria received in the data and to create corresponding sub-groups. The same may be carried out in a situation in which the predefined data is the data packages to be used in the software update and the data packages carry, e.g. as the metadata, different characteristics defining the passenger conveyors for which the data package in question shall be used for the software update. Based on such data the control system 110 may be configured to perform a data search in the database to find out the passenger conveyors meeting the one or more characteristics and form the sub-groups accordingly, i.e. through the division 310. For sake of clarity it is worthwhile to mention that the sub-groups may comprise passenger conveyors residing remotely from each other. As an example one passenger conveyor from the conveyor system referred with 120 in FIG. 1 as well as the passenger conveyor of the conveyor system referred with 130 in FIG. 1 may belong to a first sub-group whereas the other passenger conveyors of FIG. 1 may belong to one or more other sub-groups.

In addition to the aspects in relation to the division 310 to the sub-groups as described in the foregoing description the control system 110 may be provided with internal rules to be applied in the division 310. For example, a rule according to an example embodiment may define that a predefined number of conveyor systems belonging to the same conveyor group are allowed to be updated at the same time. The predefined number may e.g. be one or at least defining that not all are updated in the same sub-group. In this manner it may be guaranteed that at least some conveyor systems are still serving the tenants in spite of the software update delivery. The same approach in fundamental level may be extended to be applied in a wider area than only in one conveyor group (cf. a building) wherein the area may be defined in a local district level or a city level in order to guarantee there are enough technicians to handle any error situation caused by the software update e.g. if the technicians need to visit sites. Further rules may also be developed e.g. by defining timing aspects of the updates e.g. inside the sub-group.

Following to the division 310 to the plurality of sub-groups the control system 110 is configured to select 320 a sub-group of passenger conveyors from the fleet of sub-groups for the software update. The selection 320 may be performed based on one or more predefined criteria. In accordance with an embodiment a criterion may be a size of the sub-group, i.e. how many passenger conveyors are included in the respective sub-groups. In a preferred approach the sub-group in which are the lowest number of passenger conveyors may e.g. be selected, because if something goes wrong in the software update the harm is minimized. According to another approach the criterion may an urgency of the software update which may e.g. be indicated in the data received by the control system 110 in relation to the software update process. For example, such piece of data may be received together with the software packages, or separately to them e.g. in a control signal. The urgency of the software update is a meaningful factor in a sense that by carrying out the software update accordingly further problems, or even safety risks, may be avoided. In the selection 320 of the first sub-group further criteria may be applied to or it may be performed e.g. randomly.

Now, the control system 110 is aware of the sub-group of passenger conveyors to which the software update is to be performed and it starts delivering 330 data to the passenger conveyors belonging to the selected sub-group. Prior to the delivery of date 330 the control system 110 may determine connection details to the respective passenger conveyors e.g. by inquiring those from the data storage, such as from the database, storing data in relation to the passenger conveyors as described in the foregoing description. Hence, the control system 110 may establish a communication connection towards the passenger conveyors of the sub-group and deliver data to the respective passenger conveyors belonging to the sub-group of passenger conveyors for performing the software update. The data delivered 330 herein may refer to a data package comprising at least the software data for performing the update or it may comprise triggering data causing the update of the software already delivered to the respective passenger conveyors earlier, such as separately from the control system 110. Thus, the data may trigger the software update in the respective passenger conveyors. As a result, the passenger conveyors belonging to the sub-group in question are caused to perform the software update wherein the update is performed in a predefined schedule, such as immediately or in accordance with a predefined plan. In some approaches the passenger conveyors may be allowed to perform the software update in their own schedule with predefined time frame, e.g. based on a traffic situation or any similar criterion.

In step 340 the control system 110 is configured to receive 340 data indicative on a state of the software update in the first sub-group in which the software update in the respective passenger conveyors was triggered. This refers to an operation that the control system 110 receives 340 data based on which it may evaluate the software update process, such as has it been successful or not. The data may be received automatically from the passenger conveyors of the sub-group triggered to the software update or it may be inquired by the control system 110 in a predefined manner. In accordance with an embodiment the control system 110 may be configured to receive an acknowledgement signal from the respect passenger conveyors in response to a successful software update. An instruction to generate such an acknowledgement signal may be included in the software data of the data package which is executed by the passenger conveyor in question. For example, the entity under software update is arranged to execute the software update process and when it is done an execution of the updated software causes a generation of the acknowledgement signal to the control system 110. In accordance with another embodiment the control system 110 may be arranged to access data descriptive of the passenger conveyors being so-called online. This may refer to that the passenger conveyors may be configured to indicate that they are ready for serving the passengers and by making the control system 110 aware of this it may evaluate the situation with the software updates. Namely, when the software update is performed by a passenger conveyor it is out of use and, thus, dropped out from the online. Hence, if the software update is successful the passenger conveyor in question return online, e.g. through an internal testing process, and the control system 110 may conclude that the software update has been successful. It may also be arranged that the control system 110 executes a testing process towards the updated passenger conveyors prior to continuing the process. For sake of completeness it is worthwhile to mention that any other applicable data than disclosed above may be used descriptive on the state of the software update in the passenger conveyors.

As mentioned, the control system 110 may be configured to receive 340 the data indicative on the state of the software update from the passenger conveyors caused to perform the software update. The receipt 340 of the data may, in accordance with an embodiment of the invention, be expected to occur within a predefined time window, e.g. from the delivery of the data enabling the software update. At some point of time, e.g. after the time defined by the time window has lapsed, the control system 110 may evaluate a success rate of the software update based on the received 340 data. For example, the control system 110 may be configured to determine a success rate of the software update in the selected sub-group e.g. in percentages by dividing the number of successful updates with the total number of requested updates. The number of successful updates may e.g. correspond the ones from which data indicative on the successful update is received and the total number of requested updates may correspond to the number of passenger conveyors in the sub-group in question. In response to the determination of a value descriptive of the success of the software update in the sub-group the control system 110 may compare the value to a reference value which defines a required level (cf. requirement) at which the whole update process in the respective sub-group may be considered to have been successful. In other words, if the determined success rate, or any corresponding value, meets (e.g. exceeds/is less than) the reference value, a detection result may be generated 350 indicating that the software update process in the sub-group has gone as expected, i.e. been successful.

The receipt of the data 340 from the passenger conveyors may also be arranged to be continuous and a cumulative success rate value is continuously determined for the sub-group in question. At some point the success rate may reach the reference level and the detection result may accordingly be generated in the step 350. Even in the case of the continuous determination of the success rate, its duration is advantageously limited somehow in order to allow the process to continue in a manner as disclosed in the forthcoming description.

All in all, the control system 110 is able to generate 350 a detection result with respect to the state of the software update initiated in the passenger conveyors in the first sub-group. In accordance with the invention the control system 110 is configured to select, in response to a detection that the state of the software update in the first sub-group meets the reference value, at least one second sub-group of passenger conveyors for the software update. In other words, the triggering factor to continue the software update is the evaluation if the software update of the previous sub-group has met predefined requirements defined in the reference value. Hence, as schematically illustrated the process illustrated as the method in FIG. 3 returns to the step of the selection 320 of the second sub-group for which the software update is to be performed. Hence, the control system 110 is configured to carry out the steps 330-350 as illustrated in FIG. 3 to the new sub-group selected in the step 320. It is clear that the same procedure may iteratively be continued as long as the detection result received in the step 350 through the evaluation as described complies with requirements. Also worthwhile to mention is that the reference value for evaluating the success of the software update may be defined separately for each sub-group to be updated. For example, a machine-learning model may be trained to evaluate the execution of the success of the software update from various viewpoints and arranged to adjust the reference value accordingly.

It may also occur that the outcome of the step 350 is that the software update in a certain sub-group does not meet the reference value, i.e. deviates from it, which is descriptive on that the software update is not successful in the respective sub-group. In that case the control system 110 may be configured to generate 360 a control signal canceling the software update process. This may at least be performed with respect to any further sub-groups. The control signal may e.g. be an internal signal in the control signal to cause canceling of the software update process in any further sub-groups, but it may also cause a generation of the same, or a further control signal, e.g. to conveyors belonging to at least some of the sub-groups and/or to an entity delivering the software updates in order to inform them on that the update process is not successful with the update package delivered. Moreover, the control system 110 may be configured to take corrective actions with respect to the sub-group whose software update process caused the detection result indicating an unsuccessful software update procedure. This may refer to that the control system 110 generates a control signal instructing the passenger conveyors of the respective sub-group failing to meet the requirement to revert back to the previous software version executed in the respective passenger conveyors prior to the software update process. If necessary, the control system 110 may also deliver any necessary data in order to roll-back to the previous software version in the respective passenger conveyors.

The above described process as schematically illustrated in FIG. 3 enables an execution of a software update process to a fleet of conveyor systems in a controlled manner. Especially, in case something goes wrong in the software update the described mechanism enables minimizing damages in the fleet in various ways. First of all, even if something goes wrong, the previous state is easier to return since the software update is performed in batches and the number of recoverable entities is manageable.

For avoidance of any doubt the method described herein is applicable both in a situation in which the same software package is used for the software update in all the passenger conveyors belonging to the fleet of passenger conveyors and in a situation that there are different software packages for at least some sub-groups.

In accordance with an embodiment the division 310 to a plurality of sub-groups may be dynamic. Namely, the control system 110 may be configured to adjust the sub-groups e.g. in accordance with a result of the step 350 in the method. For example, it may be arranged that if the control system 110 detects that the success rate, or any corresponding value, meets the reference value with a predefined margin (e.g. clearly exceeds it) in an update of a certain sub-group, it may be configured to increase the speed of the software update process over the whole fleet by adjusting the size, or other characteristics, of one or more latter sub-groups to be updated. For example, the control system 110 may combine at least some sub-groups, or adjust the passenger conveyors selected in the sub-groups e.g. based on an application area of them, and, thus, perform the software update to a larger number of passenger conveyors at the same time in order to speed up the process. This kind of approach is especially favorable in a situation that the same software package is used for the software update in all sub-groups, or at least in those sub-groups adjusted to belong together in the adjusted sub-group. The same applies if the adjustment is performed on a passenger conveyor basis in order to form the new sub-group.

As a non-limiting example of the approach discussed in the previous paragraph it may be arranged that the passenger conveyors of the sub-groups, or at least the first sub-group, are selected based on their application areas. For example, the first sub-group may comprise the passenger conveyors of at least residential buildings belonging to the fleet. Depending on the outcome of the result of the step 350 of the method a composition of any latter sub-groups may be updated in accordance with the outcome. For example, the size of any latter sub-group may be adjusted and/or the application area(s) of the passenger conveyors included in the latter sub-groups may be adjusted, e.g. to minimize any risk or harm due to unsuccessful update in any previous sub-groups. For sake of completeness it is worthwhile to mention that the adjustment of the sub-groups may be implemented in the described manner based on the outcome of the update of the passenger conveyors in one or more previous sub-groups.

At least some aspects in relation to the present invention is described herein by referring to that a software executed by the passenger conveyor is updated. This refers to that at least one software executed by at least one entity of the passenger conveyor belonging to the fleet is updated. In other words, the passenger conveyors may comprise a plurality of entities in which some software is executed which may be updated. A concrete example of such an entity in the passenger conveyor may be a controller of the passenger conveyor, such as an elevator controller in which a control software for managing an operation of the elevator is executed. The software may require update and, therefore, the update process as described in the description herein may be applied to with respect to the elevator controller. Generally speaking any controller belonging to the passenger conveyor may execute a computer program requiring a software update at some point of its lifetime and the method may be applied in that as long as the respective entity is communicatively reachable either directly or indirectly.

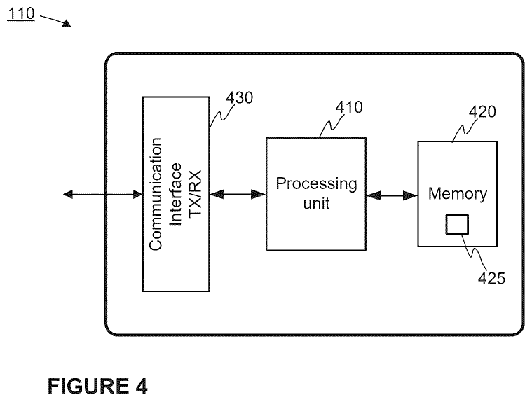

An example of an apparatus suitable to perform the role of the control system 110 executing the method is schematically illustrated in FIG. 4. Thus, the apparatus of FIG. 4 may be configured to perform a management of a software update of a fleet of passenger conveyors. For sake of clarity, it is worthwhile to mention that the block diagram of FIG. 4 depicts some components of an entity that may be employed to implement a functionality of the control system 110. The apparatus of FIG. 4 comprises a processor 410 and a memory 420. The memory 420 may store data, such as pieces of data as described, but also computer program code 425 causing the operation in the described manner. The apparatus may further comprise a communication interface 430, such as a wireless communication interface or a communication interface for wired communication, or both to communicate with other entities as described. The communication interface 430 may thus comprise one or more modems, antennas, and any other hardware and software for enabling an execution of the communication e.g. under control of the processor 410. Furthermore, I/O (input/output) components may be arranged, together with the processor 410 and a portion of the computer program code 425, to provide a user interface for receiving input from a user, such as from a technician, and/or providing output to the user of the apparatus when necessary. In particular, the I/O components may include user input means, such as one or more keys or buttons, a keyboard, a touchscreen, or a touchpad, etc. The I/O components may include output means, such as a loudspeaker, a display, or a touchscreen. The components of the apparatus may be communicatively connected to each other via data bus that enables transfer of data and control information between the components.

The memory 420 and at least a portion of the computer program code 425 stored therein may further be arranged, with the processor 410, to cause the apparatus to perform at least a portion of a method as is described herein. The processor 410 may be configured to read from and write to the memory 420. Although the processor 410 is depicted as a respective single component, it may be implemented as respective one or more separate processing components. Similarly, although the memory 420 is depicted as a respective single component, it may be implemented as respective one or more separate components, some, or all of which may be integrated/removable and/or may provide permanent/semi-permanent/dynamic/cached storage.

The computer program code 425 may comprise computer-executable instructions that implement functions that correspond to steps implemented in the method when loaded into the processor 410 of the respective apparatus. As an example, the computer program code 425 may include a computer program consisting of one or more sequences of one or more instructions. The processor 410 is able to load and execute the computer program by reading the one or more sequences of one or more instructions included therein from the memory 420. The one or more sequences of one or more instructions may be configured to, when executed by the processor 410, cause the apparatus, such as a computer implementing a server device, to perform a method as described. Hence, the apparatus may comprise at least one processor 410 and at least one memory 420 including the computer program code 425 for one or more programs, the at least one memory 420 and the computer program code 425 configured to, with the at least one processor 410, cause the apparatus to perform the method.

The computer program code 425, or at least some portion of it, may be provided e.g. a computer program product comprising at least one computer-readable non-transitory medium having the computer program code 425 stored thereon, which computer program code 425, when executed by the processor 410 causes the apparatus to perform the method. The computer-readable non-transitory medium may comprise a memory device or a record medium, such as a CD-ROM, a DVD, a Blu-ray disc, or another article of manufacture that tangibly embodies the computer program. As another example, the computer program may be provided as a signal configured to reliably transfer the computer program.

Still further, the computer program code 425 may comprise a proprietary application, such as computer program code for causing an execution of the method in the manner as described in the description herein.

Any of the programmed functions mentioned may also be performed in firmware or hardware adapted to or programmed to perform the necessary tasks.

For sake of completeness it is worthwhile to mention that the entity performing the method in the role of the apparatus may also be implemented with a plurality of apparatuses, such as the one schematically illustrated in FIG. 4, as a distributed computing environment corresponding to an apparatus so as to form the control system 110. For example, one of the apparatuses may be communicatively connected with the other apparatuses, and e.g. share the data of the method, to cause another apparatus to perform at least one other portion of the method. As a result, the method performed in the distributed computing environment (cf. cloud computing) generates the control signal indicative of the assignment of the responsibility as described.

Still further, for sake of interpretation of the description of the invention herein the term passenger conveyor used herein may also be interpreted to comprise building integrated people flow devices, such as automatic doors or turnstiles, as these are typically maintained by the same manufacturers or maintenance service providers as the said passenger conveyor devices and therefore can benefit from the invention as well.

The specific examples provided in the description given above should not be construed as limiting the applicability and/or the interpretation of the appended claims. Lists and groups of examples provided in the description given above are not exhaustive unless otherwise explicitly stated.

What is claimed is:

1. A method for managing a software update of a fleet of passenger conveyors, the method, performed by a control system, comprises:
dividing the fleet of passenger conveyors to a plurality of sub-groups of passenger conveyors in order to perform the software update on a sub-group basis, the division is performed by applying at least one criterion in allocating a passenger conveyor to the sub-group,
selecting a first sub-group of passenger conveyors from the fleet of sub-groups for the software update,
delivering data to one or more passenger conveyors belonging to the first sub-group of passenger conveyors for performing the software update,
receiving data indicative on a state of the software update in the first sub-group of passenger conveyors,
selecting, in response to a detection that the state of the software update in the first sub-group of passenger conveyors meets a reference value, at least one second sub-group of passenger conveyors for the software update.

2. The method according to claim 1, wherein the division to the plurality of sub-groups of passenger conveyors is performed based on at least one characteristic of the passenger conveyors.

3. The method according to claim 2, wherein at least one predefined rule is additionally applied in the division to the plurality of sub-groups of passenger conveyors.

4. The method according to claim 3, wherein the at least one predefined rule causes at least one of the following: a prevention to include all passenger conveyors from a same conveyor group to the sub-group in the division; controlling the number of passenger conveyors from a predefined area to be included to the sub-group in the division.

5. The method according to claim 1, wherein the division of the passenger conveyors to the sub-group is adjusted based on a detection result descriptive of the state of the software update in at least one previous sub-group of passenger conveyors.

6. The method according to claim 1, wherein the data delivered to the one or more passenger conveyors belonging to the first sub-group of passenger conveyors comprises at least one of the following: data package comprising the data of the software update; a triggering data causing the passenger conveyor receiving the triggering data to perform the software update.

7. The method according to claim 1, wherein the detection is performed over a predefined time window.

8. The method according to claim 1, the method further comprises:
generating, in response to a detection that the state of the software update in the first sub-group of passenger conveyors does not meet the predefined reference value, a control signal to cancel the software update.

9. The method according to claim 8, wherein, in response to the canceling of the software update, a control signal is generated to the first sub-group of passenger conveyors to cause a roll-back to a previous software version.

10. A control system for managing a software update of a fleet of passenger conveyors, the control system is configured to:
divide the fleet of passenger conveyors to a plurality of sub-groups of passenger conveyors in order to perform the software update on a sub-group basis, the division is performed by applying at least one criterion in allocating a passenger conveyor to the sub-group,
select a first sub-group of passenger conveyors from the fleet of sub-groups for the software update,
deliver data to one or more passenger conveyors belonging to the first sub-group of passenger conveyors for performing the software update,
receive data indicative on a state of the software update in the first sub-group of passenger conveyors,
select, in response to a detection that the state of the software update in the first sub-group of passenger conveyors meets a reference value, at least one second sub-group of passenger conveyors for the software update.

11. The control system according to claim 10, wherein the control system is configured to perform the division to the plurality of sub-groups of passenger conveyors based on at least one characteristic of the passenger conveyors.

12. The control system according to claim 11, wherein the control system is configured to additionally apply at least one predefined rule in the division to the plurality of sub-groups of passenger conveyors.

13. The control system according to claim 12, wherein the application of the at least one predefined rule causes the control system to perform at least one of the following: a prevention to include all passenger conveyors from a same conveyor group to the sub-group in the division; controlling the number of passenger conveyors from a predefined area to be included to the sub-group in the division.

14. The control system according to claim 10, wherein the control system is configured to adjust the division of the passenger conveyors to the sub-group based on a detection result descriptive of the state of the software update in at least one previous sub-group of passenger conveyors.

15. The control system according claim 10, wherein the control system is configured to include in the data delivered to the one or more passenger conveyors belonging to the first sub-group of passenger conveyors at least one of the following: data package comprising the data of the software update; a triggering data causing the passenger conveyor receiving the triggering data to perform the software update.

16. The control system according to claim 10, wherein the control system is configured to perform the detection over a predefined time window.

17. The control system according to claim 10, the control system is further configured to:
generate, in response to a detection that the state of the software update in the first sub-group of passenger conveyors does not meet the predefined reference value, a control signal to cancel the software update.

18. The control system according to claim 17, wherein the control system is configured to, in response to the canceling of the software update, generate a control signal to the first sub-group of passenger conveyors to cause a roll-back to a previous software version.

19. A computer program comprising instructions to cause a device to execute the steps of the method of claim 1.
